(19) United States
(12) Patent Application Publication
(10) Pub. No.: US 2011/0178959 A1
(43) Pub. Date: Jul. 21, 2011

(54) CHARGE AND DISCHARGE CONTROL DEVICE

(75) Inventors: Tetsu Nakajima, Kanagawa-ken (JP); Noritaka Deguchi, Kanagawa-ken (JP)

(73) Assignee: KABUSHIKI KAISHA TOSHIBA, Tokyo (JP)

(21) Appl. No.: 12/874,566

(22) Filed: Sep. 2, 2010

(30) Foreign Application Priority Data
Jan. 19, 2010 (JP) 2010-009421

(51) Int. Cl. G06F 17/00

(52) U.S. Cl. 705/412

(57) ABSTRACT

A charge and discharge control device for controlling a battery in an electric vehicle to be charged and discharged with electricity, the electricity being transmitted and received through a power line, and being bought and sold, includes a switching unit, a communication unit, a determination unit and a controller. The switching unit switches charge and discharge. The communication unit receives current electricity price. The determination unit determines first and second electricity price thresholds. The first electricity price threshold is determined using difference between current and start times, and difference between current and target amounts of charge. The second electricity price threshold is equal to or larger than the first electricity price threshold. The controller controls the switching unit to charge the battery if the current electricity price is smaller than the first electricity price threshold, and discharge if the current electricity price is larger than the second electricity price threshold.

### CROSS-REFERENCE TO RELATED APPLICATION

This application is based upon and claims the benefit of priority from Japanese Patent Application No. 2010-009421, filed on Jan. 19, 2010, the entire contents of which are incorporated herein by reference.

### FIELD

Embodiments described herein relate generally to a charge and discharge control device.

### BACKGROUND

In the Smart Grid, a technique, in that a battery of an electric vehicle is used as a buffer to control supplying electricity, has been proposed. JP-A2008-54439 (KOKAI) discloses the technique to charge and discharge the battery of the electric vehicle according to demand of electricity at home or amount of carbon dioxide emission from generation facility, for example.

However, in the above technique, the battery may continue to being discharged, if the demand of electricity reaches a peak or if the amount of the carbon dioxide emission keeps being large. In this case, since only less amount of electricity may be left in the battery, a user could not drive the electric vehicle with high utility.

### BRIEF DESCRIPTION OF THE DRAWINGS

Aspects of this disclosure will become apparent upon reading the following detailed description and upon reference to the accompanying drawings. The description and the associated drawings are provided to illustrate embodiments of the invention and not limited to the scope of the invention.

FIG. 1 is a block diagram showing a charge and discharge system according to a first embodiment;

FIG. 2 is a flowchart for explaining operation mode of a charge and discharge control unit;

FIG. 3 is a figure showing an example of electricity price varying with time;

FIG. 4 is a figure showing another example of electricity price varying with time;

FIG. 5 is a figure showing another example of electricity price varying with time;

FIG. 6 is a figure showing another example of electricity price varying with time; and

FIG. 7 is a figure showing an example of amount of charge varying with time.

### DETAILED DESCRIPTION

According to one aspect of the invention, a charge and discharge control device for controlling a battery in an electric vehicle to be charged and discharged with electricity, the electricity being transmitted and received through a power line, the electricity being bought and sold, includes a switching unit to switch charging and discharging the battery, the battery being charged with the electricity received through the power line, the battery being discharged to transmit the electricity through the power line; a communication unit to receive a current electricity price, the current electricity price varying with time; a determination unit to determine a first electricity price threshold and a second electricity price threshold, the first electricity price threshold being determined by using a difference of between a current time and a start time at which the electric vehicle is expected to start driving, and further using a difference of between a current amount of charge which is remaining in the battery and a target amount of charge which is required when the electric vehicle starts to drive at the start time, the second electricity price threshold being equal to or larger than the first electricity price threshold; and a controller to control the switching unit to charge the battery if the current electricity price is smaller than the first electricity price threshold, and to discharge the battery if the current electricity price is equal to or larger than the second electricity price threshold.

According to another aspect of the invention, a charge and discharge control device for controlling a battery in an electric vehicle to be charged and discharged with electricity, the electricity being transmitted and received through a power line, the electricity being bought and sold, comprising: a switching unit to switch charging and discharging the battery, the battery being charged with the electricity received through the power line, the battery being discharged to transmit the electricity through the power line; a communication unit to receive a time-series data of electricity price, the electricity price varying with time; a determination unit to determine a first electricity price threshold and a second electricity price threshold, the first electricity price threshold being determined by using an average data or a middle value of the time-series data during a certain duration, and further using a difference of between a current amount of charge which is remaining in the battery and a target amount of charge which is required when the electric vehicle starts to drive at the start time, the second electricity price threshold being equal to or larger than the first electricity price threshold; and a controller to control the switching unit to charge the battery if the current electricity price is smaller than the first electricity price threshold, and to discharge the battery if the current electricity price is equal to or larger than the second electricity price threshold.

The embodiments will be explained with reference to the accompanying drawings.

### Description of the First Embodiment

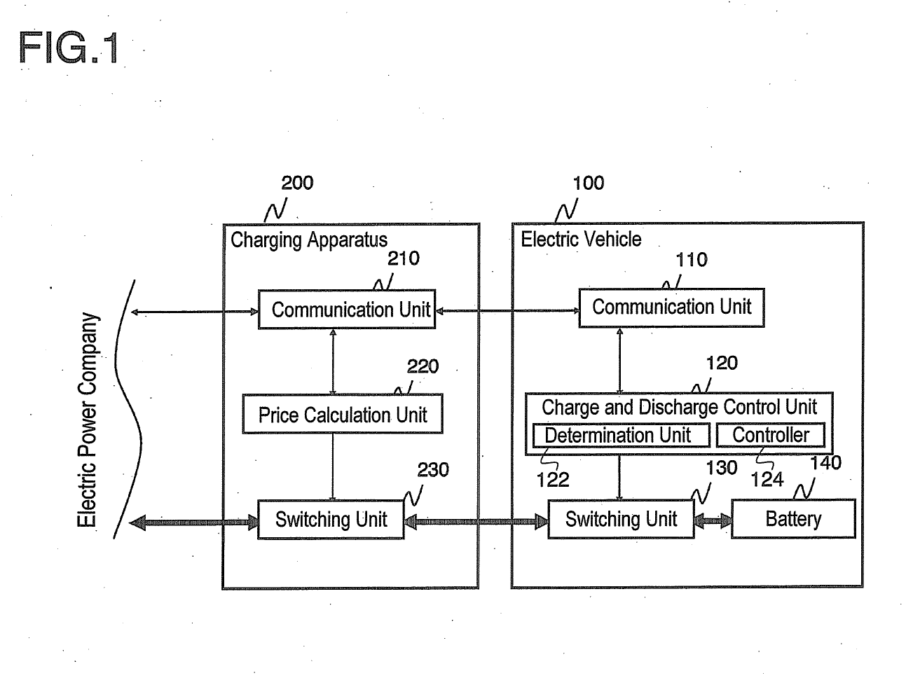

FIG. 1 is a block diagram showing a charge and discharge system according to a first embodiment. In FIG. 1, thin lines show communication (information) lines and thick lines shows power lines. The charge and discharge system includes a charging apparatus 200 and an electric vehicle 100. The electric vehicle 100 includes a battery 140 to store electricity and drives by using the electricity in the battery 140. The charging apparatus 200 charges the battery 140 of the electric vehicle 100 during parking the electric vehicle 100. The charging apparatus 200 may be installed in a parking area such as a home, an office, and a shopping center. The charging apparatus 200 may also be installed into a stand for charging in a coin parking. During parking the electric vehicle 100, the charging apparatus 200 is connected to the electric vehicle 100 by using the power line and the communication line. The power line is used to transmit and receive electricity. The communication line of between the charging apparatus 200 and the electric vehicle 100 is used to transmit and receive a data indicating electricity price and an information indicating a switching between charge and discharge. The electricity price varies with time. The charging apparatus 200 is also connected to an electric power company by using the power line and the communication line. The communication line of between the charging apparatus 200 and the electric power company is used to transmit and receive an information such as current electricity price, purchase electricity price and sale electricity price. The communication line of between the electric vehicle 100 and the charging apparatus 200, and the communication line of between the charging apparatus 200 and the electric power company, may be provided by using wireless medium or wired medium which are different from the power line. Or, each of the communication lines may be provided by a line which works as both the power line and the communication line according to the power line communications (PLC).

The electric vehicle 100 includes a communication unit 110, a charge and discharge control unit 120, a switching unit 130 for switching charge and discharge, and a battery 140. The communication unit 110 receives the information of current electricity price in real time through the charging apparatus 200. The communication unit 110 may receive the information of current electricity price in real time from the electric power company directly. The charge and discharge control unit 120 includes a determination unit 122 and a controller 124. The controller 124 controls the switching unit 130 to switch charge, discharge and open of the battery 140. Note that, open of the battery 140 means that the battery 140 is not charged and not discharged. The determination unit 122 determines at least one electricity price threshold which is used to switch charge, discharge, and open. The charge and discharge control unit 120 determines to performs one of charge, discharge, or open of the battery 140 by using a time difference (hereinafter, referred to as “remaining time”) of between a current time and a start time at which the electric vehicle is expected to start driving, using a difference of between the electricity amount which currently stored in the battery 140 and the electricity amount which is required when the electric vehicle 100 starts to drive, and further using the current electricity price indicated in real time. Then, the charge and discharge control unit 120 (the controller 124) controls the switching unit 130 according to above determination of charge, discharge, or open. The detail of the charge and discharge control unit 120 is described later. Electricity to be charged into the battery 140 is bought from the electric power company. On the other hand, electricity discharged from the battery 140 is sold to the electric power company. The switching unit 130 switches charging the battery 140 or discharging the battery 140 according to instruction from the charge and discharge control unit 120 (the controller 124). If the switching unit 130 is opened, the battery 140 does not perform both charge and discharge. The communication unit 110 transmits a signal (hereinafter, referred to as “indication signal”) to the charging apparatus 200. The indication signal indicates which is performed charge, discharge, or open for the battery 140.

The charging apparatus 200 includes a communication unit 210, a price calculation unit 220, and a switching unit 230 for switching charge and discharge. The communication unit 210 receives a current electricity price from the electric power company in real time. Then, the communication unit 210 transmits the current electricity price to the electric vehicle 100 immediately. The communication unit 210 also receives the indication signal indicating one of charge, discharge, and open from the electric vehicle 100. The switching unit 230 switches connect and open of the power line of between electric power company and the electric vehicle 100 according to the indication signal from the electric vehicle 100. The price calculation unit 220 calculates purchase electricity price and sale electricity price based on amount of the electricity flowing through the switching unit 230. The price calculation unit 220 also calculates a total electrical price by subtracting the purchase electricity price from the sale electricity price (The total electrical price=the purchase electricity price−the sale electricity price). The total electrical price corresponds to amount of the electricity used by a user of the electric vehicle 100.

Next, we will describe the charge and discharge control unit 120 of the electric vehicle 100 in detail. The charge and discharge control unit 120 receives the electricity price in real time from a MDMS (Meter Data Management System) server of the electric power company through the charging apparatus 200. The charge and discharge control unit 120 obtains a time at when the electric vehicle 100 is expected to be used next (hereinafter, referred to as “start time”). The start time may be inputted from an input interface (I/F) by the user of the electric vehicle 100. The input I/F may be included in the electric vehicle 100 or the charging apparatus 200. Or, the start time may be predicted based on a history of using the electric vehicle 100 in past. A remaining time until start time is calculated by subtracting a current time from the start time. Further, the charge and discharge control unit 120 obtains current amount of charge in the battery 140. The charge and discharge control unit 120 also obtains amount of charge which is required when the electric vehicle starts to drive at the start time (hereinafter, referred to as “target amount of charge”). The target amount of charge may be variable depending on a driving distance expected for a next driving. Otherwise, the target amount of charge may be a fixed percentage, such as 100%, 80%, which may be inputted by the user.

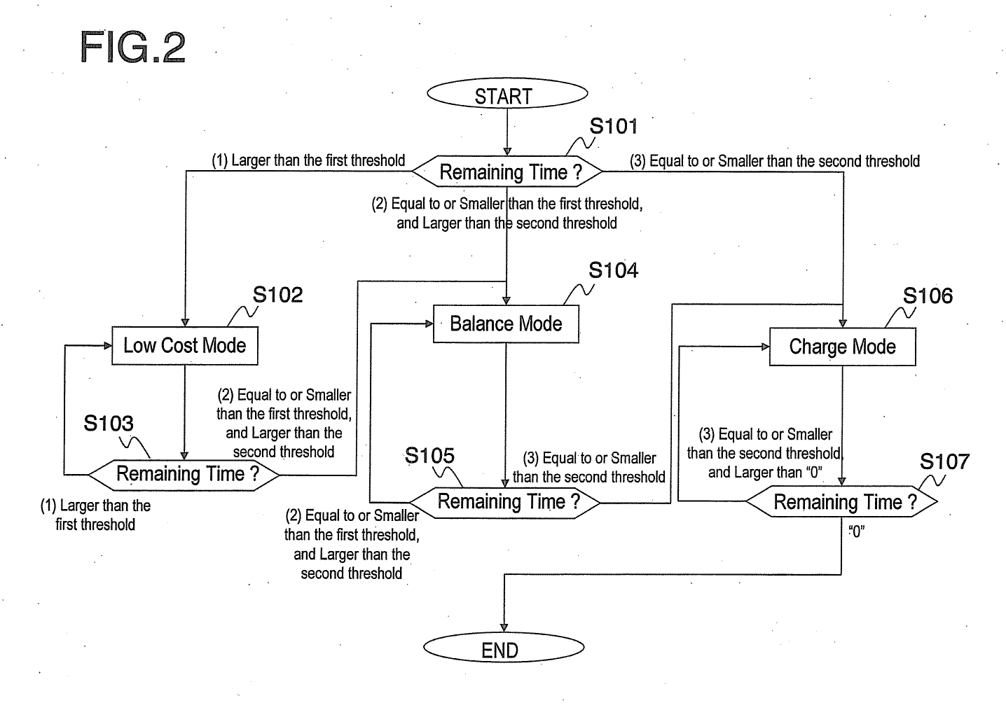

FIG. 2 is a flowchart for explaining operation mode of the charge and discharge control unit 120. The charge and discharge control unit 120 switches the operation mode according to the remaining time until the start time. The charge and discharge control unit 120 has three modes, which are “low cost mode”, “balance mode”, and “charge mode”. The low cost mode is to reduce the total electricity price. The charge mode is to charge the battery 140 rapidly. The balance mode is to perform both reducing the total electricity price and charging the battery 140 rapidly. The charge and discharge control unit 120 uses a different algorithm for each mode in order to determine which is performed, charge, discharge, or open. If the remaining time is larger than a first threshold (in (1) of the step S101 and in (1) of the step S103), the charge and discharge control unit 120 operates in the low cost mode (in the step S102). If the remaining time is equal to or smaller than the first threshold and larger than a second threshold (in (2) of the step S101, in (2) of the step S103, and in (2) of the step S105), the charge and discharge control unit 120 operates in the balance mode (in the step S104). If the remaining time is equal to or smaller than the second threshold (in (3) of the step S101, in (3) of the step S105, and in (3) of the step S107), the charge and discharge control unit 120 operates in the charge mode (in the step S106).

The first threshold is determined based on a time (base time) at which the electricity price becomes smaller than a middle value or an average value of electricity prices of for a certain term (for example, for n days, where n is an integer and equal to or larger than 1). For example, in the case that the electric vehicle 100 is parking from 15:00 to 24:00 and the electricity price becomes smaller than the middle value or the average value at 20:00, the first threshold may be 4 [hours]. The base time at which the electricity price becomes smaller than a middle value or an average value may be predicted from a history of the electricity price in past. Or, the base time may be a detected time when the electricity price actually becomes smaller than a middle value or an average value. More electricity may be consumed in homes from 15:00 to 20:00 because of dinner, for example. Therefore, supply of the electricity may be tight, and the electricity price tends to be more expensive. On the other hand, less electricity may be consumed in homes after 20:00. Accordingly, the electricity price tends to be cheaper. According to the above tendencies, the base time could be predicted to be 20:00.

The second threshold is determined by subtracting current amount of charge in the battery 140 from the target amount of charge to obtain a result, and dividing the result by an amount of charge per an hour. In an example that maximum amount of charge in the battery 140 is 200 [kWh], current amount of electricity charged in the battery 140 is 40[%] of the maximum amount of charge (80 [kWh]), the target amount of charge is 80[%] of the maximum amount of charge (160 [kWh]), and amount of charge per an hour is 40 [kW/h], the second threshold is 2 [hour].

Next, we will describe how the charge and discharge control unit 120 determines the electricity price threshold in each of the modes. The electricity price threshold is used to switch charge and discharge.

<Case of One Electricity Price Threshold>

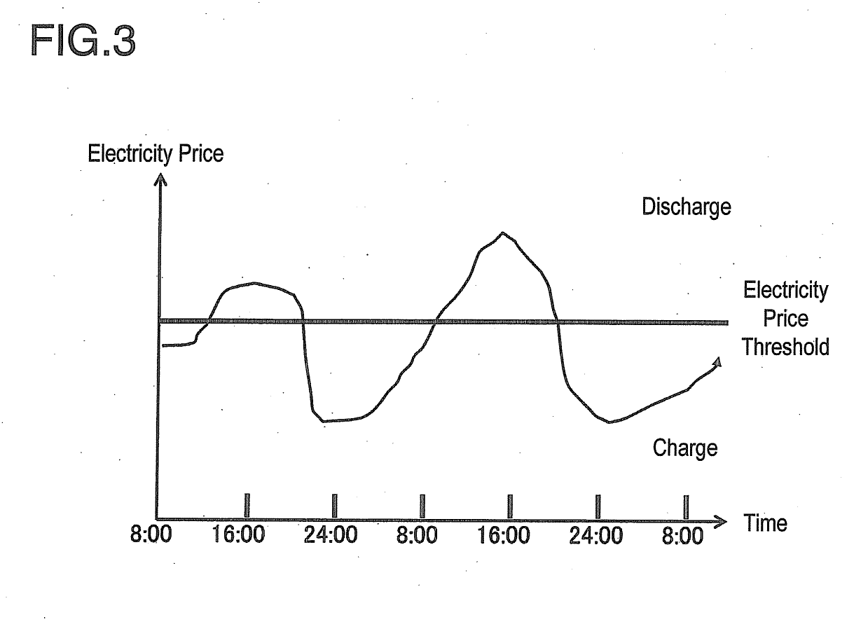

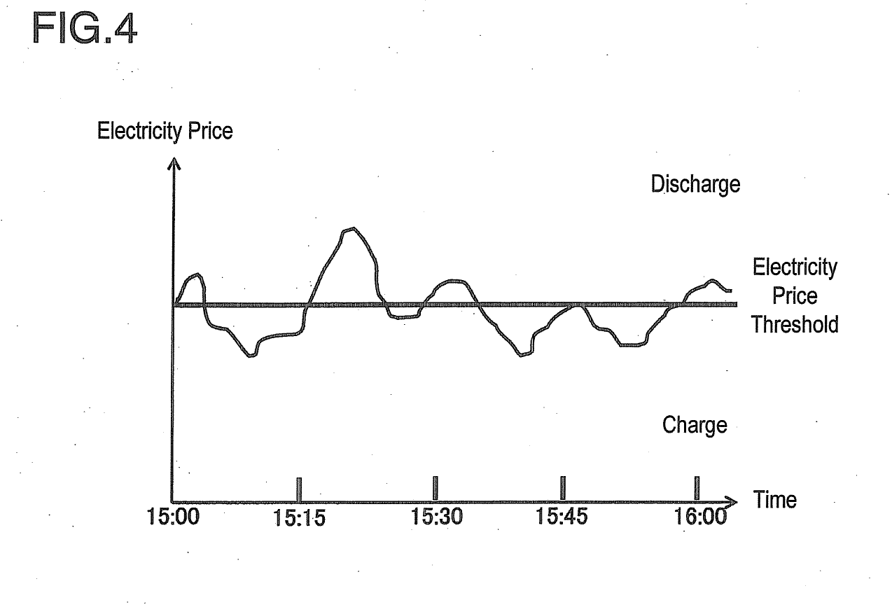

FIGS. 3 and 4 are figures showing examples of electricity price varying with time. FIG. 3 shows the electricity price varying with time during 2 days (48 hours). FIG. 4 shows the electricity price varying with time during 1 hour. Note that, the electricity price threshold is fixed in the examples of FIGS. 3 and 4 for simplicity. However, the electricity price threshold may be adaptable according to switching the mode or changing the certain term to watch the electricity price varying with time. The charge and discharge control unit 120 determines to discharge from the battery 140, if the electricity price is equal to or larger than the electricity price threshold. The charge and discharge control unit 120 determines to charge into the battery 140, if the electricity price is smaller than the electricity price threshold.

[Low Cost Mode]

The charge and discharge control unit 120 determines that the electricity price threshold is a middle value or an average value among history of the electricity price of for a certain term. The middle value is calculated by adding the most expensive electricity price to the cheapest electricity price among the history of the electricity price of for a certain term to obtain a result, and dividing the result by 2. That is, the middle value=(the most expensive electricity price+the cheapest electricity price)/2. On the other hand, the average value is calculated by {(an electricity price at a first time+an electricity price at a second time+ . . . +an electricity price at a n-th time)/n}. Hereinafter, the middle value or the average value is called as a base value. Length of the certain term for watching the electricity prices to calculate the base value, is not limited. In the case of parking for a long term (more than 1 day), the electricity price can be reduced more effectively by using electricity price of the latest long term (more than 1 day, 1 week, and 1 month, for example). As shown in FIG. 3, in the case of parking for a long term, the electricity price has large difference depending on time in a day, for example, day or night. In this case, the time in a day may be divided into two time zones, one is a more expensive time zone (for example, from 6:00 to 22:00 in FIG. 3) and the other is a cheaper time zone (for example, from 22:00 to 6:00 in FIG. 3). The electricity price threshold can be calculated individually in each time zone. The number of the time zones is not limited to two, but may be more than three. The time in a day may be divided into some time zones by using the base vale. For example, in the some time zones, an average electricity price per hour is larger than the base value. In the other time zones, the average electricity price per hour is smaller than the base value.

On the other hand, in the case of parking for a short term (about 30 minutes to 3 hours), the electricity prices can be reduced more effectively by using one of time-series data of electricity price for the latest short term (about 30 minutes to one hour), time-series data of electricity price since starting to park, and time-series data of electricity price corresponding same time zone in past, or combination of these time-series data.

[Balance Mode]

The charge and discharge control unit 120 determines that the electricity price threshold is a value which is equal to or larger than the base value and has larger value with having larger difference of between the target amount of charge and the current amount of charge in the battery 140. For example, the electricity price threshold is calculated by multiplying difference of between the maximum electricity price and the base value by difference (for example, 40%=80%−40%) of between the target amount of charge (for example, 80%) and the current amount of electricity (for example, 40%), to obtain a result, and then, adding the result to the base value. According to the above calculation, when remaining amount of charge in the battery 140 is less, amount of electricity to be charged increases. Moreover, amount of electricity to be charged decreases with increasing the remaining amount of charge in the battery 140. Thus, the charge and discharge control unit 120 can reduce the cost with charging the battery 140 at a same time.

[Charge Mode]

The charge and discharge control unit 120 determines that the electricity price threshold is infinity. This leads to charge the battery 140 rapidly. Even in the charge mode, the charge and discharge control unit 120 may control the switching unit 130 to open or discharge when receiving a request to reduce power consumption from the electric power company by a demand response.

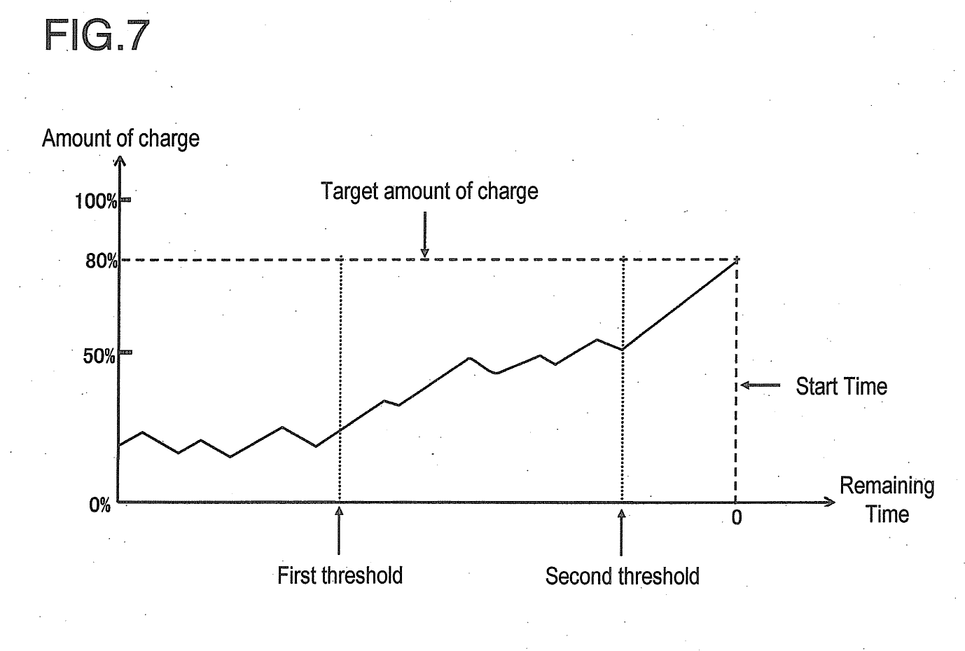

FIG. 7 is a figure showing an example of amount of charge in the battery 140 varying with time, when the charge and discharge control unit 120 uses one electricity price threshold to control switching charge and discharge in each mode. When the remaining time is larger than a first threshold (in the low cost mode), reducing cost is achieved while amount of charge slightly increases by repeating charge and discharge. When the remaining time is equal to or smaller than the first threshold and larger than a second threshold (in the balance mode), the charge and discharge control unit 120 achieve a good balance between charging the battery 140 and reducing cost. This is because that the charge and discharge control unit 120 instructs to charge a lot if the difference, of between the target amount of charge and the current amount of charge in the battery 140 is large. Moreover, the charge and discharge control unit 120 controls the switching unit 130 to repeat charge and discharge the battery 140 with approaching to the target amount of charge. When the remaining time is equal to or smaller than the second threshold (in the charge mode), the charge and discharge control unit 120 instructs the switching unit 130 to charge rapidly. This achieves to complete charging the target amount of charge until the start time.

<Case of Two Electricity Price Thresholds>

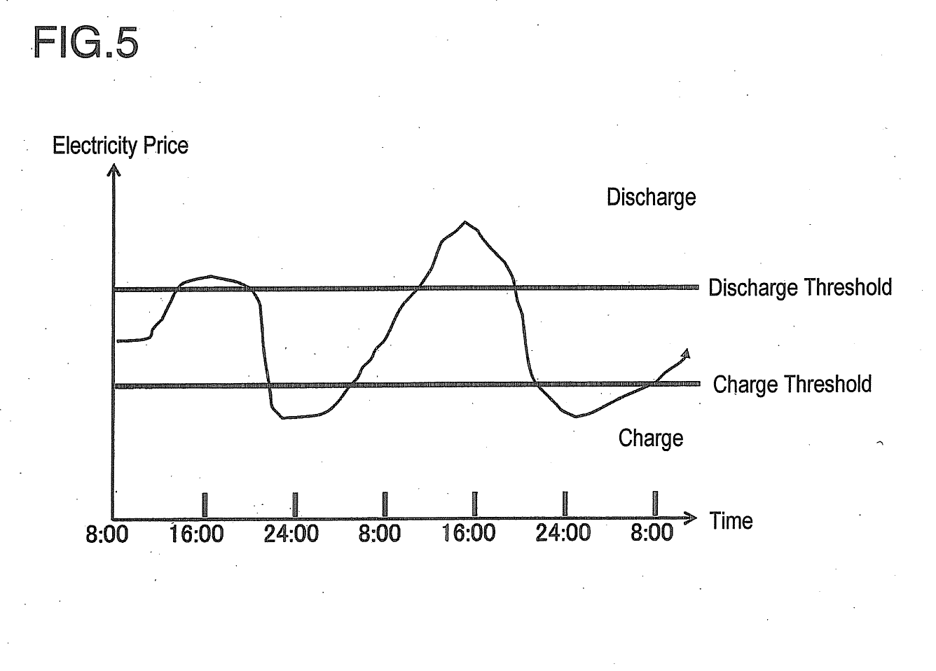

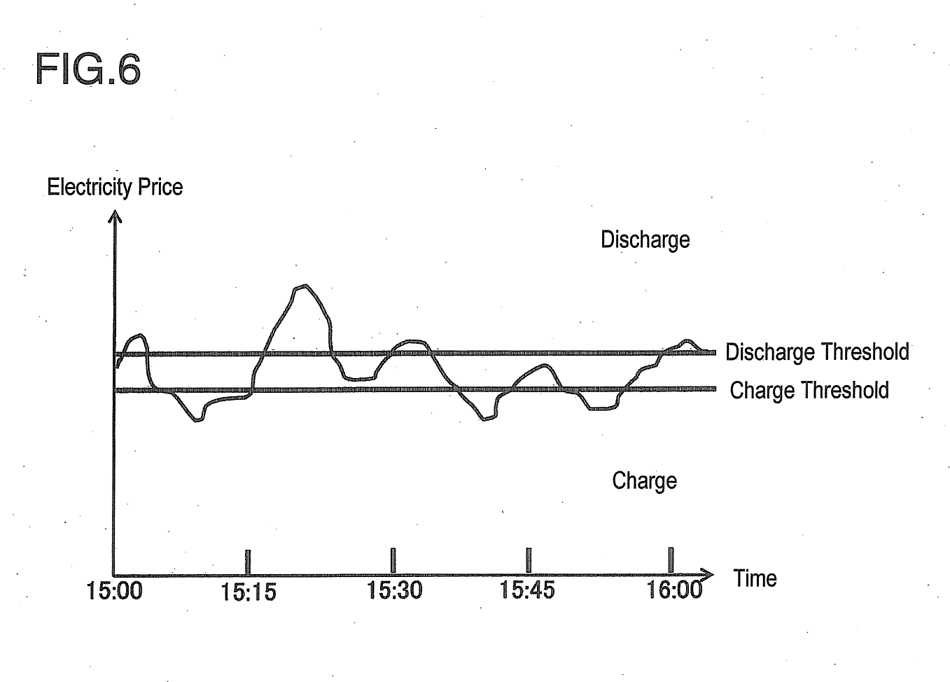

FIGS. 5 and 6 are figures showing other examples of electricity price varying with time, when first and second electricity price thresholds are used. The first electricity price threshold is to determine whether or not charge is performed (hereinafter, referred to as “charge threshold”). The second electricity price threshold is to determine whether or not discharge is performed (hereinafter, referred to as “discharge threshold”). FIG. 5 shows the electricity price varying with time during 2 days (48 hours). FIG. 6 shows the electricity price varying with time during 1 hour. Note that, the charge threshold and the discharge threshold are fixed values in the examples of FIGS. 5 and 6 for simplicity. However, the charge threshold and the discharge threshold may vary with time.

The charge and discharge control unit 120 determines to discharge from the battery 140, if the electricity price is equal to or larger than the discharge threshold. On the other hand, the charge and discharge control unit 120 determines to charge the battery 140, if the electricity price is smaller than the charge threshold. Further, the charge and discharge control unit 120 determines to open the battery 140, if the electricity price is smaller than the discharge threshold and the electricity price is equal to or larger than the charge threshold. Next, we will describe how the charge and discharge control unit 120 determines the charge threshold and the discharge threshold in each of the modes.

[Low Cost Mode]

The charge and discharge control unit 120 determines that the discharge threshold is a value which is equal to or smaller than the maximum electricity price and larger than the base value. The charge and discharge control unit 120 determines that the charge threshold is a value which is equal to or larger than the minimum electricity price and smaller than the base value. For example, the discharge threshold may be a value which is obtained by adding a half of the difference between the maximum value and the base value to the base value. Similarly, the charge threshold may be a value which is obtained by subtracting a half of the difference between the minimum value and the base value from the base value. This can reduce the total electricity price effectively.

[Balance Mode]

The charge and discharge control unit 120 determines that the charge threshold is a value which is equal to or larger than the charge threshold of the low cost mode, and equal to or smaller than the discharge threshold of the low cost mode. The charge threshold becomes a larger value with having the larger difference of between the target amount of charge and the current amount of charge in the battery 140. For example, the charge threshold is calculated by multiplying difference of between the charge threshold and the discharge threshold of the low cost mode by difference (for example, 40%=80%−40%) of between the target amount of charge (for example, 80%) and the current amount of charge (for example, 40%), to obtain a result, and then, adding the result to the charge threshold of the low cost mode. According to the above calculation, when remaining amount of charge in the battery 140 is less, amount of electricity to be charged increases. Moreover, amount of electricity to be charged decreases with increasing the remaining amount of charge in the battery 140. Thus, the charge and discharge control unit 120 can reduce the cost with charging the battery 140 at a same time.

[Charge Mode (which is Equivalent to the Case of the One Threshold)]

The charge and discharge control unit 120 determines that both charge and discharge thresholds are infinity. This leads to charge the battery 140 rapidly. Even in the charge mode, the charge and discharge control unit 120 may control the switching unit 130 to open or discharge when receiving a request to reduce power consumption from the electric power company by a demand response.

According to the first embodiment, in the charge and discharge system, the charge and discharge control unit 120 controls the battery 140 by using the difference of between the current time and the start time at which the electric vehicle 100 will be started to use, and using the difference of between the current amount of charge in the battery 140 and the target amount of charge which is required to start driving the electric vehicle 100 at the start time. This realizes controlling supply and demand of the electricity, and reducing the total electricity price with keeping utility of the electric vehicle 100.

### Modified Example 1

In the first embodiment, the charge and discharge control unit 120 is included in the electric vehicle 100. However, the charge and discharge control unit may be included in the charging apparatus 200. In this case, the charge and discharge control unit receives a current electricity price from the electric power company through the communication unit 210 in real time. The charge and discharge control unit also receives a current amount of charge from the electric vehicle 100 through the communication units 110, 210. By using them, the charge and discharge control unit controls the battery 140 to perform one of the charge, discharge, and open. The charge and discharge control unit transmits an indication signal to the electric vehicle 100 in order to control the battery 140 to perform one of the charge, discharge, and open. This realizes controlling supply and demand of electricity, and reducing the total electricity price with keeping utility of the electric vehicle 100 as same as the first embodiment.

### Modified Example 2

In the first embodiment and the modified example 1, the charge and discharge control unit operates in the three modes which are the “low cost mode”, “balance mode”, and “charge mode”. However, in the case of parking for a short term, the charge and discharge control unit may not operate in the low cost mode, but may first operate in the balance mode, and then, may switch to the charge mode. When the remaining amount of charge in the battery 140 of the electric vehicle 100 is large at start of parking, the charge and discharge control unit may operate only in the low cost mode. When the electric vehicle 100 is going to drive long distance and expect to reduce the total electricity price, the charge and discharge control unit may operate only in the balance mode.

While certain embodiments have been described, these embodiments have been presented by way of example only, and are not intended to limit the scope of the inventions. Indeed, the novel systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A charge and discharge control device for controlling a battery in an electric vehicle to be charged and discharged with electricity, the electricity being transmitted and received through a power line, the electricity being bought and sold, comprising:
a switching unit to switch charging and discharging the battery, the battery being charged with the electricity received through the power line, the battery being discharged to transmit the electricity through the power line;
a communication unit to receive a current electricity price, the current electricity price varying with time;
a determination unit to determine a first electricity price threshold and a second electricity price threshold, the first electricity price threshold being determined by using a first difference of between a current time and a start time at which the electric vehicle is expected to start driving, and further using a second difference of between a current amount of charge which is remaining in the battery and a target amount of charge which is required when the electric vehicle starts to drive at the start time, the second electricity price threshold being equal to or larger than the first electricity price threshold; and
a controller to control the switching unit to charge the battery if the current electricity price is smaller than the first electricity price threshold, and to discharge the battery if the current electricity price is equal to or larger than the second electricity price threshold.

2. The device of claim 1, wherein
the determination unit, if the first difference is equal to or larger than a time threshold, determines that the first electricity price threshold is a value which is smaller than a base value and the second electricity price threshold is a value which is larger than the base value, the base value being an average value or a middle value of electricity prices of a certain duration, and
the determination unit, if the first difference is smaller than the time threshold, determines that the first electricity price threshold is a value which is equal to or smaller than the second electricity price threshold, and determines that the first electricity price threshold is a larger value when the second difference is larger.

3. The device of claim 1, wherein
the determination unit, if the first difference is equal to or larger than a time threshold, determines that the first electricity price threshold and the second electricity price threshold are values which are respectively equal to a base value, the base value being an average value or a middle value of electricity prices of a certain duration, the first electricity price threshold being equal to the second electricity price threshold, and
the determination unit, if the first difference is smaller than the time threshold, determines that the first electricity price threshold and the second electricity price threshold are values which are respectively equal to or larger than the base value, and determines that the first electricity price threshold and the second electricity price threshold are larger values when the second difference is larger.

4. The device of claim 1, wherein
the determination unit, if a current time is earlier than a base time, determines that the first electricity price threshold is a value which is smaller than a base value, the base value being an average value or a middle value of electricity prices of a certain duration, the base time being a time at which the electricity price becomes smaller than an average value or a middle value of electricity prices for a duration which is longer than 24 hours, and
the determination unit, if a current time is later than the base time, determines that the first electricity price threshold is a value which is equal to or larger than the first electricity price threshold which is used before the base time, and determines that the first electricity price threshold is a larger value when the second difference is larger.

5. A charge and discharge control device for controlling a battery in an electric vehicle to be charged and discharged with electricity, the electricity being transmitted and received through a power line, the electricity being bought and sold, comprising:
a switching unit to switch charging and discharging the battery, the battery being charged with the electricity received through the power line, the battery being discharged to transmit the electricity through the power line;
a communication unit to receive a time-series data of electricity price, the electricity price varying with time;
a determination unit to determine a first electricity price threshold and a second electricity price threshold, the first electricity price threshold being determined by using an average data or a middle value of the time-series data during a certain duration, and further using a difference of between a current amount of charge which is remaining in the battery and a target amount of charge which is required when the electric vehicle starts to drive at the start time, the second electricity price threshold being equal to or larger than the first electricity price threshold; and
a controller to control the switching unit to charge the battery if the current electricity price is smaller than the first electricity price threshold, and to discharge the battery if the current electricity price is equal to or larger than the second electricity price threshold.
